(19) United States
(12) Patent Application Publication
(10) Pub. No.: US 2013/0180379 A1
(43) Pub. Date: Jul. 18, 2013

(54) METHOD, SYSTEM, AND APPARATUS FOR NODAL FRET WIRE

(71) Applicant: Samuel T. Artioli, Capitola, CA (US)

(72) Inventor: Samuel T. Artioli, Capitola, CA (US)

(21) Appl. No.: 13/351,957

(22) Filed: Jan. 17, 2012

(51) Int. Cl. G10D 3/06

(52) U.S. Cl. 84/314 R

(57) ABSTRACT

The present invention contemplates a variety of methods, systems, and apparatuses for Nodal Fret Wire. Nodal Fret Wire is an enhancement to traditional fret wire that allows the creation of a node at any fret-string intersection on a stringed instrument when used in conjunction with a Node Creation Device. A Node Creation Device holds down a musical instrument string directly adjacent to and behind a Nodal Fret Wire. Mutually connecting parts on the Node Creation Device and the Nodal Fret Wire secure the Node Creation Device to the Nodal Fret Wire. The Node Creation Device pushes the musical instrument string down into contact with the crown of the Nodal Fret Wire. This contact creates a node, which a player of the musical instrument uses to form musical notes.

### FIELD OF THE INVENTION

The present invention relates to stringed instruments and more specifically to fret wire used to make frets for the fingerboard of a stringed instrument.

### BACKGROUND OF INVENTION

Frets are used on stringed musical instruments to facilitate the forming of chords. A chord, as used here, is one or more pitched musical notes played simultaneously, or the position used to produce such notes. Usually, a stringed instrument has a number of frets inserted in the instrument's fingerboard at varied distances from the instrument's bridge. Pressing on a string behind a fret (FIG. 1) creates a node at said fret, allowing the string to vibrate between that fret and the bridge of the stringed musical instrument, sounding a note. The pitch of the note is dependent upon the thickness of the string and the distance of the fret from the bridge. The most common ways to press on a string are either with one's finger, or with an accessory such as a capo. A drawback of using one's finger is that the note will only sound as long as one's finger is pressing on the string. The drawbacks of using capos are that capos may only cover a certain number of strings, are bulky, and in general can only be used in a localized area of the fingerboard. The present invention makes it possible to create nodes at any fret-string interface location in conjunction with a Node Creation Device.

### SUMMARY OF THE INVENTION

The present invention contemplates a variety of methods, systems, and apparatuses for Nodal Fret Wire. Nodal Fret Wire is an enhancement to traditional fret wire that allows the creation of a node at any fret-string intersection on a stringed instrument when used in conjunction with a Node Creation Device. A Node Creation Device holds down a musical instrument string directly adjacent to and behind a Nodal Fret Wire. Mutually connecting parts on the Node Creation Device and the Nodal Fret Wire secure the Node Creation Device to the Nodal Fret Wire. The Node Creation Device pushes the musical instrument string down into contact with the crown of the Nodal Fret Wire. This contact creates a node, which a player of the musical instrument uses to form musical notes.

A first aspect of the present invention provides a Nodal Fret Wire comprising a fret wire having securing modifications. The modified fret is used to facilitate the creation of a node at a fret-string intersection on a stringed musical instrument, generally in conjunction with a Node Creation Device. While securing modifications to a fret wire vary, embodiments may include the addition of holes or a ledge to the crown of the fret to facilitate interaction with the Node Creation Device.

A second aspect of the present invention provides a Node Creation Device comprising protruding feet for holding a node in place at a fret-string intersection, an open area between the feet to house an instrument string, and a handle for ease of use. Generally, the Node Creation Device is used in conjunction with a Nodal Fret Wire, where the protruding feet connect with receiving sections on the Nodal Fret Wire. While Node Creation Devices may vary with respect to certain aspects, embodiments may include, for example, devices with long narrow feet in order to connect with Nodal Fret Wire having holes or devices with short feet in order to connect with Nodal Fret Wire having a ledge.

A third aspect of the present invention provides a Node Creation System comprising a Nodal Fret Wire and a Node Creation Device compatible with the Nodal Fret Wire. Generally, a string is caught under the Node Creation Device. The Node Creation Device is placed directly adjacent to and behind the Nodal Fret Wire at a fret-string intersection and the Node Creation Device forces the string to make contact with the crown of the Nodal Fret Wire. The Nodal Fret Wire, Node Creation Device, and string are held in place by mutually connecting parts on the Node Creation Device and the Nodal Fret Wire.

### BRIEF DESCRIPTION OF DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 illustrates a node created by pressing on a string behind a fret;

FIG. 2 illustrates a side view of traditional fret wire;

FIG. 3 illustrates an angled view of traditional fret wire;

FIG. 4 illustrates an angled view of an envisioned embodiment of the invention having holes through the crown of a Nodal Fret Wire;

FIG. 5 illustrates a front view of FIG. 4;

FIG. 6 illustrates a side view of an envisioned embodiment of the invention having ledges along the crown of a Nodal Fret Wire;

FIG. 7 illustrates an angled view of FIG. 6;

FIG. 8 illustrates an angled view of an envisioned embodiment of a Node Creation Device;

FIG. 9 illustrates a node created by using a Node Creation Device and an envisioned embodiment of the invention having holes through the crown of a Nodal Fret Wire;

FIG. 10 illustrates an angled and closer view of FIG. 9;

FIG. 11 illustrates an angled view of an envisioned embodiment of a Node Creation Device;

FIG. 12 illustrates a node created by using a Node Creation Device and an envisioned embodiment of the invention having ledges along the crown of a Nodal Fret Wire; and

FIG. 13 illustrates an angled and closer view of FIG. 12.

The drawings are not necessarily to scale. The drawings are merely schematic representations, not intended to portray specific parameters of the invention. The drawings are intended to depict only typical embodiments of the invention, and therefore should not be considered as limiting the scope of the invention. When used, like numbering represents like elements.

### DETAILED DESCRIPTION OF THE INVENTION

The device or apparatus of the present invention adds modifications or features to traditional fret wire, allowing these fret wires to create nodes at any fret-string intersection when used with Node Creation Devices. Multiple nodes may be created on a musical instrument at separate fret-string intersections and held in place for an extended period of time, allowing for a variety of musical applications.

Embodiments of the present invention provide a variety of devices and apparatuses including a Nodal Fret Wire that allows frets of a stringed instrument to create nodes at any fret-string intersection when used in combination with a Node Creation Device. A musical instrument string is caught under a Node Creation Device directly adjacent to and behind a Nodal Fret Wire. Mutually connecting parts on the Node Creation Device and the Nodal Fret Wire (modified from a traditional fret wire to have a mutually connecting part) secure the Node Creation Device to the Nodal Fret Wire. The Node Creation Device pushes the instrument string down into contact with the crown of the Nodal Fret Wire. This contact creates a node, which a player of the musical instrument uses to form musical notes.

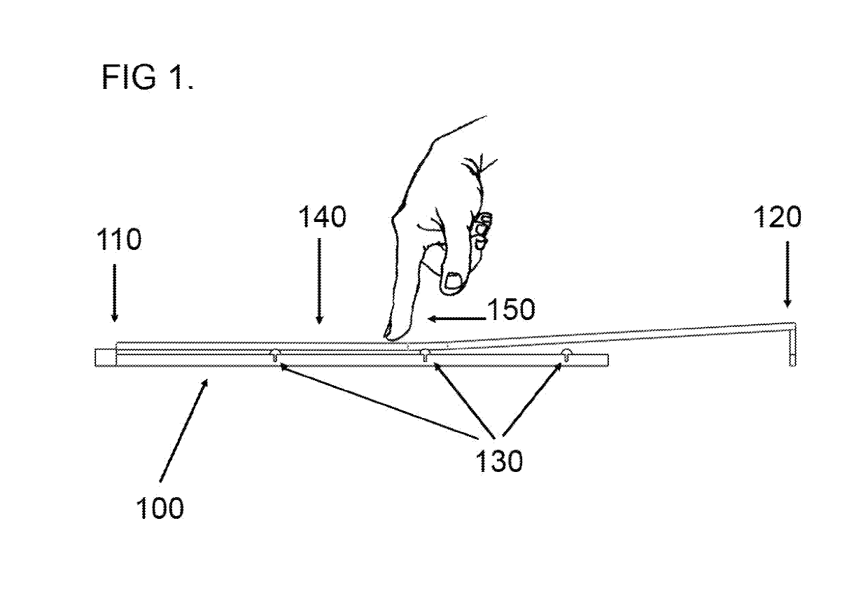

Referring now to FIG. 1, formation of a traditional node is illustrated. The node is created by pressing on string 140 behind traditional fret 130. Traditional frets 130 are inserted in fingerboard 100 and string 140 is strung from nut 110 to bridge 120. Pressing on string 140 right behind a fret, e.g. traditional fret 130 in FIG. 1, creates a node at that particular fret so that string 140 can vibrate between traditional fret 130 and bridge 120 to produce a note. Usually, the pressing is applied with finger 150 or an accessory such as a carpo (not pictured).

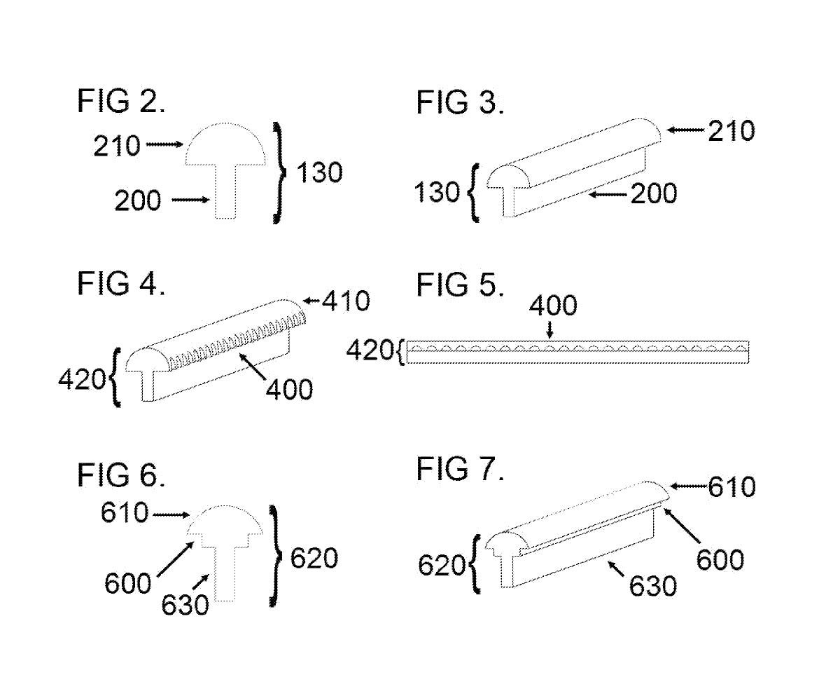

Referring now to FIG. 2 and FIG. 3, a side view and angled view, respectively, of traditional fret wire 130 is shown. Tang 200 fits into grooves on a fingerboard (e.g. fingerboard 100 of FIG. 1) of a stringed instrument. Traditional crown 210, often in the shape of a half cylinder cut along the central axis, generally sits flush on the fingerboard with respect to the flat face. For example, FIG. 1 shows traditional fret wire 130 fitting into groves in fingerboard 100.

Referring now to FIG. 4 and FIG. 5, an angled and front view, respectively, of an envisioned embodiment of the invention is shown having holes 400 through holed crown 410 of holed nodal fret wire 420. Holed crown 410 is depicted as a half cylinder whose bottom face may sit flush on a fingerboard, although other variations and modifications may be envisioned. Holes 400 are located through the lower portion of holed crown 410 and in parallel with the strings of the instrument on which the fret wire is fitted. This placement allows holed nodal fret wire 420 to still function as a fret while also enabling the creation of nodes at any fret-string interface when holed nodal fret wire 420 is used as Nodal Fret Wire, with a Node Creation Device, as will be discussed in detail further below. Generally, holes 400 secure a Node Creation Device to holed nodal fret wire 420.

FIG. 6 illustrates a side view, while FIG. 7 illustrates an angled view, of an envisioned embodiment of the invention having ledge 600 along semi half-cylindrical ledged crown 610 of ledged nodal fret wire 620. These ledges have a shorter width than the radius of semi half-cylindrical ledged crown 610 in order to leave a face that makes contact with a fingerboard and to not cut into tang 630 of ledged nodal fret wire 620. The bottom face of ledged crown 610 sits flush with a fingerboard at the interface of ledged crown 610 and tang 630, securing ledged nodal fret wire 620 to the fingerboard. Ledge 600 enables the creation of nodes at any fret-string intersection when ledged nodal fret wire 620 is used as Nodal Fret Wire, with a Node Creation Device, as will be discussed in detail further below. Generally, ledge 600 secures a Node Creation Device to ledged nodal fret wire 620.

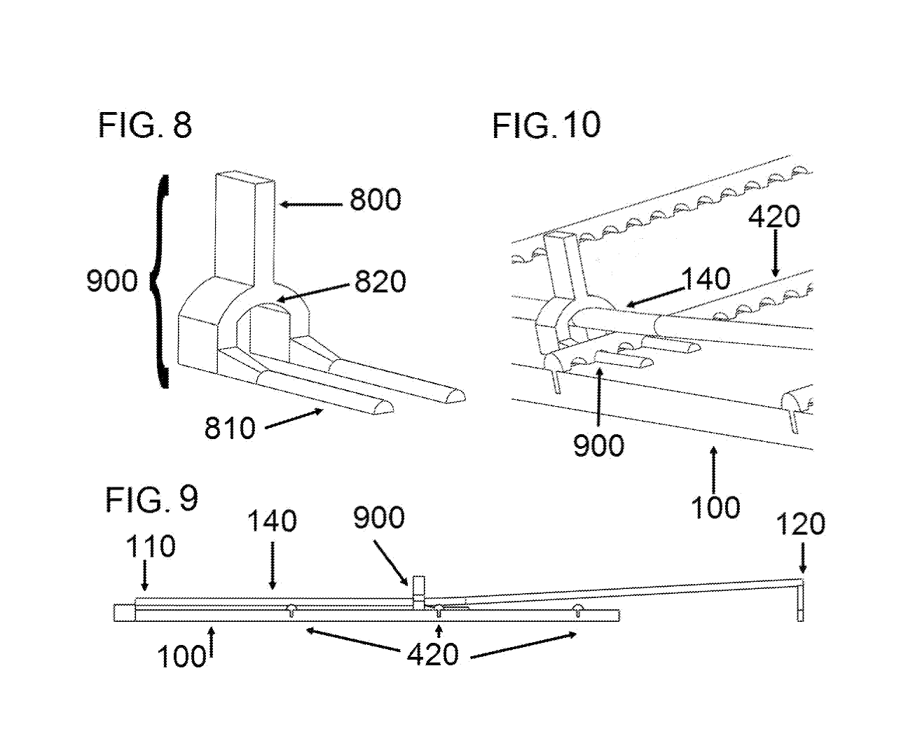

FIG. 8 illustrates an angled view of an envisioned embodiment of Node Creation Device 900. The embodiment of the Node Creation Device shown in FIG. 8 is associated with holed nodal fret wire 420, but other embodiments of the Node Creation Device are possible. This embodiment has an upside-down horseshoe shaped body 820 with a long protruding foot 810 at each end of the horse shoe, orthogonal to the main face of the horseshoe. Each protruding foot 810 is sufficiently narrow so as to be capable of entering one of holes 400 of nodal fret wire 420. The distance between long protruding feet 810 is such that a musical instrument sting fits between feet 810 and feet 810 each line up with one of holes 400 of nodal fret wire 420. When Node Creation Device 900 is used to form a node, tension is created in a string on the underside of body 820. Body 820 holds the string down and is connected to nodal fret wire 420 by feet 810, which hold Node Creation Device 900 in place. Handle 800, protruding from the apex of the horseshoe, allows the device to be easily installed and removed.

Referring now to FIG. 9 and FIG. 10, a node created by using Node Creation Device 900 and an envisioned embodiment of Nodal Fret Wire with holes through the crown of the fret wire (e.g. holed nodal fret wire 420) is illustrated. FIG. 10 shows an angled and enlarged view of FIG. 9. Node Creation Device 900, having body 820 (FIG. 8), is placed over string 140. Protruding feet 810 (FIG. 8), of the correct size to fit through the holes in the crown, are inserted in the holes of the Nodal Fret Wire. The holes in the crown allow Node Creation Device 900 to press string 140 towards fingerboard 100 while holding string 140 securely in place. String 140 makes contact with the top of crown 410, forming a node and allowing musical notes to be sounded if desired. The combined tension in string 140 and interlock between protruding feet 810 and holes anchors Node Creation Device 900 in place. The availability of holes on each fret and across the entire fingerboard, reaching each string, allows for the creation of a node at any fret-string location. Therefore, a player could create a set of nodes on a set of strings in order to temporarily program a particular chord, for example.

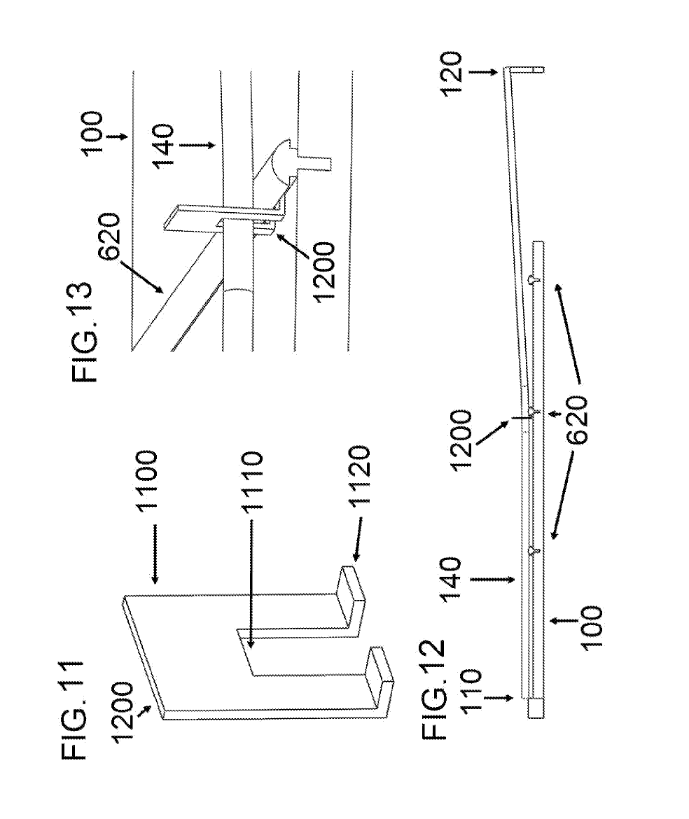

FIG. 11 illustrates an angled view of an envisioned embodiment of Node Creation Device 1200. The embodiment of the Node Creation Device shown in FIG. 11 is associated with ledged nodal fret wire 620, but other embodiments of the Node Creation Device are possible. This embodiment has a flat body with legs forming a passage through which a string of a musical instrument can pass on the underside of body 1110. At the bottom of each leg, short protruding feet 1120, bending out from the leg, connect to the body. Protruding feet 1120 fit under ledge 600 in crown 610 when nodal fret wire 620 is inserted into a fingerboard (FIG. 6). The distance between protruding feet 1120 is such that a musical instrument sting fits between feet 1120. When Node Creation Device 1200 is used to create a node, tension is created in a string on the underside of a body 1110. Body 1110 holds the string down and is connected to nodal fret wire 620 by feet 1120, which hold Node Creation Device 1200 in place. Handle 1100, which may be part of the flat body, allows the device to be easily installed and removed.

Referring now to FIG. 12 and FIG. 13, a node created by using a Node Creation Device 1200 and an envisioned embodiment of Nodal Fret Wire with ledges along the crown of the fret wire (e.g. ledged nodal fret wire 620) is illustrated. FIG. 13 illustrates an angled and enlarged view of FIG. 12. Node Creation Device 1200, having an underside of body 1110 (FIG. 11), is placed over string 140. Short protruding feet 1120 (FIG. 11), capable of fitting under the ledge along the crown, slide under the ledge of the Nodal Fret Wire. The ledge in the crown allows Node Creation Device 1200 to pull string 140 towards fingerboard 100 while securely holding string 140 in place. String 140 makes contact with the top of crown 610, forming a node and allowing musical notes to be sounded if desired. The combination of tension in string 140 and interface of protruding feet 1120 and ledge 600 anchors Node Creation Device 1200 in place. The presence of ledges on each fret and across the entire fingerboard, reaching each string, allows for the creation of a node at any fret-string location. Therefore, a player could create a set of nodes on a set of strings in order to temporarily program a particular chord, for example.

In addition to the above mentioned examples, various other modifications and alterations may be made to the invention without departing from the invention. While the invention has been particularly shown and described in conjunction with preferred embodiments thereof, it will be appreciated that variations and modifications will occur to those skilled in the art. Accordingly, the above disclosure is not to be considered as limiting and the appended claims are to be interpreted as encompassing the true spirit and the entire scope of the invention.

I claim:

1. A Nodal Fret Wire, comprising:
a fret wire; and
a securing modification to the fret wire;
where the fret wire is used in the creation of a node at a fret-string intersection on a stringed instrument.

2. The Nodal Fret Wire of claim 1, where a node creation device is secured to the fret wire.

3. The Nodal Fret Wire of claim 2, where the securing of the node creation device to the fret wire creates a node at a fret-string intersection on a stringed instrument.

4. The Nodal Fret Wire of claim 2, where the string of a stringed instrument is held between the fret wire and the node creation device.

5. The Nodal Fret Wire of claim 1, where the securing modification comprises one or more holes through the crown of the fret wire and perpendicular to the primary axis of the fret wire.

6. The Nodal Fret Wire of claim 1, where the securing modification comprises a ledge running parallel to the primary axis of the fret wire.

7. The Nodal Fret Wire of claim 1, where the fret wire is inserted into the fingerboard of a stringed instrument.

8. A Node Creation Device, comprising:
one or more a protruding feet, for creating a node at a fret-string intersection;
an open area between the feet from which material has been removed, for housing a string; and
a handle.

9. The Node Creation Device of claim 8, where the one or more a protruding feet connect with a nodal fret wire.

10. The Node Creation Device of claim 9, where the connecting with the nodal fret wire creates a node at a fret-string intersection on a stringed instrument.

11. The Node Creation Device of claim 8, where the string of a stringed instrument is caught in the open area, the open area being wide enough to hold the string.

12. The Node Creation Device of claim 8, where:
the open area is surrounded by an upside-down horseshoe shaped body,
the one or more protruding feet are narrow and long; and
the handle extends from the apex of the horseshoe shaped body.

13. The Node Creation Device of claim 8, where:
the open area is surrounded by a flat body;
the one or more protruding feet are short; and
a handle is flat and integrated into the body.

14. A Node Creation System, comprising:
a Nodal Fret Wire; and
a Node Creation Device compatible with the Nodal Fret Wire.

15. The Node Creation System of claim 14, where:
the Node Creation Device sits directly adjacent to and behind the Nodal Fret Wire at a fret-string intersection;
an instrument string is caught under the Node Creation Device;
the string makes contact with the crown of the Nodal Fret Wire; and
the Node Creation Device is secured to the Nodal Fret Wire by mutually connecting parts on the Node Creation Device and the Nodal Fret Wire.

16. The Node Creation System of claim 14, where an instrument string is trapped between and in contact with both the Node Creation Device and the Nodal Fret Wire in order to create a node.

17. The Node Creation System of claim 14, where one or more Node Creation Systems are employed on an instrument.

18. The Node Creation System of claim 17, where the one or more Node Creation Systems are employed for an extended period of time in order to play a chord repeatedly.

19. The Node Creation System of claim 14, where the Nodal Fret Wire of the system inserted onto the fingerboard of a stringed instrument.

20. The Node Creation Device of claim 14, where the Nodal Fret Wire comprises at least one of: a series of holes and a ledge, and the Node Creation Device comprises protruding feet.
